(19) United States
(12) Patent Application Publication
(10) Pub. No.: US 2024/0302501 A1
(43) Pub. Date: Sep. 12, 2024

(54) APPARATUS FOR MEASURING FIELD OF VIEW OF LIDAR AND METHOD FOR MEASURING FIELD OF VIEW OF LIDAR

(71) Applicant: HL Klemove Corp., Incheon (KR)

(72) Inventor: Hyuk RYU, Seoul (KR)

(73) Assignee: HL Klemove Corp., Incheon (KR)

(21) Appl. No.: 18/215,314

(22) Filed: Jun. 28, 2023

(30) Foreign Application Priority Data
Mar. 7, 2023 (KR) 10-2023-0030109

(51) Int. Cl. G01S 7/481; G01S 17/89

(52) U.S. Cl. CPC G01S 7/4816; G01S 7/4817; G01S 17/89

(57) ABSTRACT

An apparatus for measuring a field of view of a LiDAR and a method for measuring a field of view of a LiDAR are disclosed. The apparatus for measuring a field of view of a LiDAR for measuring a field of view of a light source provided in a LiDAR, according to an aspect of the present disclosure, may include a first reflector having a first reflective surface formed on one side of the first reflector, a cradle capable of fixing the LiDAR so that a projection area is formed on the first reflective surface by light irradiated by the light source and adjusting a distance between the first reflective surface and the light source, a camera for photographing the first reflective surface where the projection area is formed, and a calculator to determine the field of view of the light source from photographing information collected by the camera.

### TECHNICAL FIELD

The present disclosure relates to an apparatus for measuring a field of view of a Light Detection and Ranging (“LiDAR”) and a method for measuring a field of view of a LiDAR.

### DESCRIPTION OF THE RELATED ART

The field of view (FOV) of Light Detection And Ranging (LiDAR) is directly related to the sensor's detection range and operating concept. Therefore, the field of view is one of the important performance indicators of LiDAR. Accordingly, a method and technology capable of accurately evaluating the field of view for each LiDAR are essentially required.

If the LiDAR is developed directly, the internal configuration can be accurately known, but if the manufactured LiDAR is used, the internal configuration cannot be accurately known. That is, if the internal configuration of LiDAR cannot be performed, the method for evaluating the field of view is limited because the exact position of the light source cannot be known.

In addition, in order to increase the accuracy of the field of view measurement when constructing an environment for evaluating the LiDAR, high accuracy for the LiDAR mounting position is required. Accordingly, there are problems in that difficulty in manufacturing the apparatus for measuring field of view increases, manufacturing cost and period increase, and maintenance cost increases.

Therefore, there is an increasing need for an apparatus and method capable of measuring a field of view of a LiDAR regardless of the mounting accuracy even when the position of the light source is unknown.

### SUMMARY

### Technical Problem

The present disclosure is directed to providing an apparatus for measuring a field of view of a LiDAR and a method for measuring a field of view of a LiDAR capable of measuring a field of view of a light source without knowing the position of the light source inside the LiDAR.

In addition, the present disclosure is directed to providing an apparatus for measuring a field of view of a LiDAR and a method for measuring a field of view of a LiDAR, wherein the apparatus for measuring a field of view is capable of measuring the field of view of a light source even when only a part of a projection area is photographed.

In addition, the present disclosure is directed to providing an apparatus for measuring a field of view of a LiDAR and a method for measuring a field of view of a LiDAR, wherein the apparatus for measuring a field of view is capable of measuring the field of view of a light source that asymmetrically radiates light.

The problems solved by the present disclosure are not limited to those mentioned above, and other problems that are solved but not mentioned above will be clearly understood by those of ordinary skill in the art from the following description.

### Technical Solution

In order to solve such problems, embodiments of an apparatus for measuring a field of view of a LiDAR for measuring a field of view of a light source provided in a LiDAR, according to an aspect of the present disclosure, may include a first reflector having a first reflective surface formed on one side of the first reflector, a cradle capable of fixing the LiDAR so that a projection area is formed on the first reflective surface by light irradiated by the light source and adjusting a distance between the first reflective surface and the light source, a camera for photographing the first reflective surface where the projection area is formed, and a calculator to determine the field of view of the light source from photographing information collected by the camera.

In this case, the apparatus may further include a first rail extending in a direction perpendicular to the first reflective surface, and the cradle may be coupled to the first rail to reciprocate along the first rail.

In this case, when opposite ends of the projection area located on a first axis is included in the first reflective surface, the calculator may determine the field of view of the light source on the first axis.

In this case, when opposite ends of the projection area located on a second axis are further included in the first reflective surface, the calculator may determine the field of view of the light source on the second axis.

In this case, the calculator may determine the field of view of the light source by comparing photographing information taken by the camera while the cradle is located at a first position and photographing information taken by the camera while the cradle is located at a second position.

In this case, the calculator may determine the field of view of the light source using Equation 1:

$$θ = 2 \cdot {tan}^{- 1} ( \frac{W 1 - W 2}{2 \cdot ( D 1 - D 2 )} ) \qquad [ Equation 1 ]$$

(where, Θ is a field of view of the light source on the first axis, D1 is a distance from the first reflective surface to the first position, D2 is a distance from the first reflective surface to the second position, W1 is a distance between opposite ends of the projection area located on the first axis while the cradle is located at the first position, and W2 is a distance between opposite ends of the projection area located on the first axis while the cradle is located at the second position).

An apparatus for measuring a field of view of a LiDAR for measuring a field of view of a light source provided in a LiDAR, according to another aspect of the present disclosure, may include a first reflector having a first reflective surface formed on one side of the first reflector, a cradle capable of fixing the LiDAR so that a projection area formed by light irradiated by the light source is included in the first reflective surface, a second reflector that is movable between the cradle and the first reflector in a direction horizontal to the first reflector and has a second reflective surface formed on one side of the second reflector, a camera for photographing the first reflective surface and the second reflective surface on which the projection area is formed, and a calculator to determine the field of view of the light source from photographing information collected by the camera.

In this case, the apparatus may further include a second rail extending in a direction horizontal to the first reflective surface, and the second reflector may be coupled to the second rail to reciprocate along the second rail.

In this case, when one end of the projection area located on a first axis is included in the first reflective surface and one end of the second reflective surface starts to block light irradiated from the light source to one end of the projection area, the calculator may determine the field of view of the light source on the first axis.

In this case, the calculator may determine the field of view of the light source using Equation 2:

$$θ = 2 \cdot {tan}^{- 1} ( \frac{W 3}{D 3} ) \qquad [ Equation 2 ]$$

(where, Θ is a field of view of the light source on the first axis, D3 is a distance from the first reflective surface to one end of the second reflective surface, and W3 is a distance from one end of the projection area to one end of the second reflective surface along the first axis in a state in which one end of the second reflective surface starts to block light irradiated from the light source to one end of the projection area).

In this case, the apparatus may further include a third reflector that is movable between the cradle and the first reflector in a direction horizontal to the first reflective surface and has a third reflective surface formed on one side of the third reflector, and the camera may further photograph the third reflective surface where the projection area is formed.

In this case, when one end of the projection area and the other end of the projection area located on a first axis are included in the first reflective surface, one end of the second reflective surface starts to block light irradiated from the light source to one end of the projection area and one end of the third reflective surface starts to block light irradiated from the light source to the other end of the projection area, the calculator may determine the field of view of the light source on the first axis.

In this case, the calculator may determine the field of view of the light source using Equation 3:

$$θ = {tan}^{- 1} ( \frac{W 3}{D 3} ) + {tan}^{- 1} ( \frac{W 4}{D 4} ) \qquad [ Equation 3 ]$$

(where, Θ is a field of view of the light source on the first axis, D3 is a distance from the first reflective surface to one end of the second reflector, W3 is a distance from one end of the projection area to one end of the second reflective surface along the first axis in a state in which one end of the second reflective surface starts to block light irradiated from the light source to one end of the projection area, D4 is a distance from the first reflective surface to one end of the third reflective surface, and W4 is a distance from the other end of the projection area to one end of the third reflective surface along the first axis in a state in which one end of the third reflective surface starts to block light irradiated from the light source to the other end of the projection area).

In this case, one end of the second reflective surface and one end of the third reflective surface may be disposed parallel to each other in a direction parallel to the first axis.

A method for measuring a field of view of a LiDAR, according to an aspect of the present disclosure, may include coupling the LiDAR to a cradle so that a projection area is formed on a first reflective surface of a first reflector by light irradiated from a light source of the LiDAR, first adjusting a position of a cradle to a first position so that opposite ends of the projection area located on a first axis are included in the first reflective surface, first photographing the first reflective surface with a camera while the cradle is located at the first position, second adjusting a position of a cradle to a second position while opposite ends of the projection area are located on the first axis and included in the first reflective surface, second photographing the first reflective surface while the cradle is located at the second position, and determining a field of view of the light source by comparing photographing information taken while the cradle is located at the first position and photographing information taken while the cradle is located at the second position.

In this case, in the step of determining a field of view, the field of view of the light source may be determined using Equation 1:

$$θ = 2 \cdot {tan}^{- 1} ( \frac{W 1 - W 2}{2 \cdot ( D 1 - D 2 )} ) \qquad [ Equation 1 ]$$

(where, Θ is a field of view of the light source on the first axis, D1 is a distance from the first reflective surface to the first position, D2 is a distance from the first reflective surface to the second position, W1 is a distance between opposite ends of the projection area located on the first axis while the cradle is located at the first position, and W2 is a distance between opposite ends of the projection area located on the first axis while the cradle is located at the second position).

A method for measuring a field of view of a LiDAR, according to another aspect of the present disclosure, may include coupling the LiDAR to a cradle so that a projection area is formed on a first reflective surface of a first reflector by light irradiated from a light source of the LiDAR, first adjusting a position of a reflector by moving a second reflector until one end of a second reflective surface of the second reflector starts to block light irradiated from the light source to one end of the projection area located on a first axis, first generating first photographing information by photographing the first reflective surface and the second reflective surface, and determining a field of view of the light source from the first photographing information.

In this case, in the step of determining a field of view, the field of view of the light source may be determined using Equation 2:

$$θ = 2 \cdot {tan}^{- 1} ( \frac{W 3}{D 3} ) \qquad [ Equation 2 ]$$

(where, Θ is a field of view of the light source on the first axis, D3 is a distance from the first reflective surface to one end of the second reflective surface, and W3 is a distance from one end of the projection area to one end of the second reflective surface along the first axis in a state in which one end of the second reflective surface starts to block light irradiated from the light source to one end of the projection area).

In this case, prior to the determining a field of view, the method may further include second adjusting a position of a reflector by moving a third reflector until one end of a third reflective surface of the third reflector starts to block light irradiated from the light source to the other end of the projection area located on a first axis, and generating second photographing information by photographing the first reflective surface and the third reflective surface, and in the step of determining a field of view, the field of view of the light source is determined by further including the second photographing information.

In this case, in the step of determining a field of view, the field of view of the light source may be determined using Equation 3:

$$θ = {tan}^{- 1} ( \frac{W 3}{D 3} ) + {tan}^{- 1} ( \frac{W 4}{D 4} ) \qquad [ Equation 3 ]$$

(where, Θ is a field of view of the light source on the first axis, D3 is a distance from the first reflective surface to one end of the second reflector, W3 is a distance from one end of the projection area to one end of the second reflective surface along the first axis in a state in which one end of the second reflective surface starts to block light irradiated from the light source to one end of the projection area, D4 is a distance from the first reflective surface to one end of the third reflective surface, and W4 is a distance from the other end of the projection area to one end of the third reflective surface along the first axis in a state in which one end of the third reflective surface starts to block light irradiated from the light source to the other end of the projection area).

### Advantageous Effects

The apparatus for measuring a field of view of a LiDAR and the method for measuring a field of view of a LiDAR according to embodiments of the present disclosure may determine the field of view of a light source without knowing the position of the light source inside the LiDAR by moving the cradle and photographing the projection area according to the position of the LiDAR.

In addition, the apparatus for measuring a field of view of a LiDAR and the method for measuring a field of view of a LiDAR according to embodiments of the present disclosure may determine the field of view of a light source even when only a part of the projection area is photographed using the second reflector.

In addition, the apparatus for measuring a field of view of a LiDAR and the method for measuring a field of view of a LiDAR according to embodiments of the present disclosure may determine the field of view of a light source that radiates light asymmetrically, by additionally using the third reflector.

Advantageous effects of the present disclosure are not limited to the above-described effects and should be understood to include all effects that can be inferred from the configuration of the disclosure described in the description or claims of the present disclosure.

### BRIEF DESCRIPTION OF THE DRAWINGS

FIG. 1 is a top view of an apparatus for measuring a field of view of a LiDAR according to a first embodiment of the present disclosure.

FIG. 2 is a side view of an apparatus for measuring a field of view of a LiDAR according to a first embodiment of the present disclosure.

FIG. 3 is a view showing a first reflective surface of an apparatus for measuring a field of view of a LiDAR according to a first embodiment of the present disclosure.

FIG. 4 is a top view of an apparatus for measuring a field of view of a LiDAR according to a second embodiment of the present disclosure.

FIG. 5 is a side view of an apparatus for measuring a field of view of a LiDAR according to a second embodiment of the present disclosure.

FIG. 6 is a view showing a first reflective surface, a second reflective surface, and a third reflective surface of an apparatus for measuring a field of view of a LiDAR according to a second embodiment of the present disclosure.

FIG. 7 is a flow chart of a method for measuring a field of view using an apparatus for measuring a field of view of a LiDAR according to a first embodiment of the present disclosure.

FIG. 8 is a flow chart of a method for measuring a field of view using an apparatus for measuring a field of view of a LiDAR according to a second embodiment of the present disclosure.

### DETAILED DESCRIPTION OF THE EMBODIMENTS

Hereinafter, exemplary embodiments of the present disclosure will be described in detail so that those of ordinary skill in the art can readily implement the present disclosure with reference to the accompanying drawings. The present disclosure may be embodied in many different forms and are not limited to the embodiments set forth herein. In the drawings, parts unrelated to the description are omitted for clarity of description of the present disclosure, and throughout the specification, like reference numerals denote like elements.

Terms and words used in the present specification and claims should not be construed as limited to their usual or dictionary definition, and they should be interpreted as a meaning and concept consistent with the technical idea of the present disclosure based on the principle that inventors may appropriately define the terms and concept in order to describe their own disclosure in the best way.

Accordingly, the embodiments described in the present specification and the configurations shown in the drawings correspond to exemplary embodiments of the present disclosure, and do not represent all the technical idea of the present disclosure, so the configurations may have various examples of equivalent and modification that can replace them at the time of filing the present disclosure.

It should be understood that the terms “comprise” or “have” when used in this specification, are intended to describe the presence of stated features, integers, steps, operations, elements, components and/or a combination thereof but not preclude the possibility of the presence or addition of one or more other features, integers, steps, operations, elements, components, or a combination thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

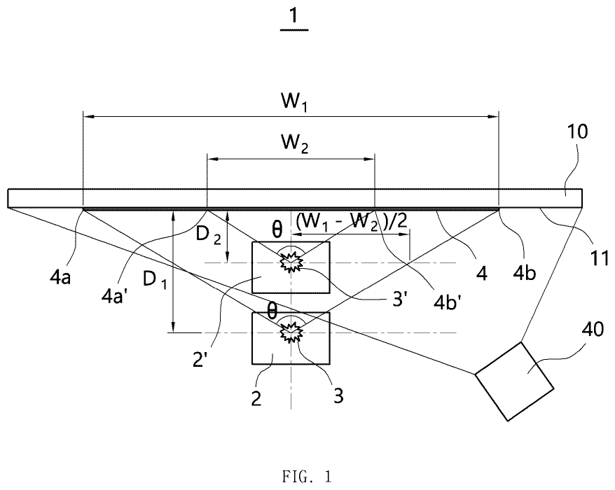

Hereinafter, an apparatus for measuring a field of view of a LiDAR according to an embodiment of the present disclosure will be described with reference to FIGS. 1 to 3.

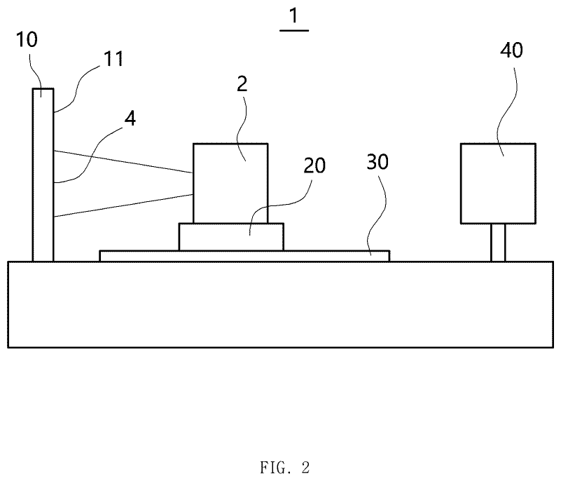

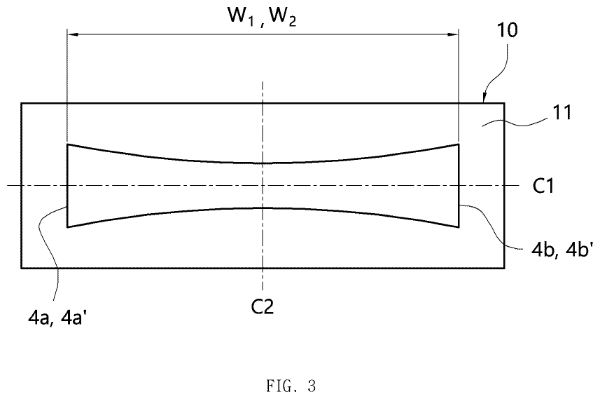

FIG. 1 is a top view of an apparatus for measuring a field of view of a LiDAR according to a first embodiment of the present disclosure. FIG. 2 is a side view of an apparatus for measuring a field of view of a LiDAR according to a first embodiment of the present disclosure. FIG. 3 is a view showing a first reflective surface of an apparatus for measuring a field of view of a LiDAR according to a first embodiment of the present disclosure.

The apparatus 1 for measuring a field of view of a LiDAR according to a first embodiment of the present disclosure measures a field of view of a light source 3 provided in a LiDAR 2. The LiDAR 2 scans a specific area by measuring the return time of emitting a laser pulse to the light source 3. Therefore, the measurement range of the LiDAR 2 is determined according to the field of view of the light source 3.

In order to measure the field of view of this LiDAR 2, the apparatus 1 for measuring a field of view of a LiDAR according to a first embodiment of the present disclosure includes a first reflector 10, a cradle 20, a first rail 30, a camera 40, and a calculator 50.

As shown in FIG. 1, a first reflective surface 11 is formed on one side of the first reflector 10. The first reflector 10 may be formed in a plate shape, but the shape is not limited as long as the first reflective surface 11 can be formed.

As shown in FIG. 2, the first reflective surface 11 is formed toward the light source 3 of the LiDAR 2. In this case, the first reflective surface 11 is formed as a flat surface. A projection area 4 may be formed on the first reflective surface 11 by light irradiated from the light source 3.

Since the field of view of the light source 3 is not affected by the distance between the first reflective surface 11 and the light source 3, in order to measure the field of view of the light source 3, if the projection area 4 that can be formed by the light source 3 by adjusting the distance between the first reflective surface 11 and the light source 3 can be included in the first reflective surface 11, the area of the first reflective surface 11 is not limited.

In addition, if the type of measurement range varies depending on the type of LiDAR 2, it may be designed differently according to the shape of the measurement range of the LiDAR 2 of the first reflective surface 11. For example, as shown in FIG. 3, since the LiDAR 2 to be measured by the apparatus 1 for measuring a field of view of a LiDAR, according to the first embodiment, is a LiDAR 2 that measures an area extending left and right, the first reflective surface 11 has a shape extending left and right.

As shown in FIG. 2, the cradle 20 may fix the LiDAR 2 so that the projection area 4 is formed on the first reflective surface 11 by the light irradiated by the light source 3. In order for the cradle 20 to fix the LiDAR 2, various known components may be used, and the cradle 20 may be replaced according to the type of the LiDAR 2.

The cradle 20 fixes the LiDAR 2 so as to maintain the direction of the light irradiated by the light source 3 of the LiDAR 2 in the process of moving. In this case, the cradle 20 may move toward the first reflective surface 11 while fixing the LiDAR 2.

In this case, the cradle 20 may reciprocate along a direction perpendicular to the first reflective surface 11. Through this, the cradle 20 may adjust the distance between the first reflective surface 11 and the light source 3 while maintaining a constant direction of light irradiated from the light source 3.

As shown in FIG. 2, the cradle 20 may be coupled to the first rail 30 so that the cradle can adjust the distance between the first reflective surface 11 and the light source 3. In this case, if the cradle 20 can move along the first rail 30, the cradle 20 and the first rail 30 may be coupled by a known coupling method.

The first rail 30 extends in a direction perpendicular to the first reflective surface 11. That is, the first reflective surface 11 of the first reflector 10 is disposed toward the light source 3 of the LiDAR 2 fixed to the cradle 20, and the cradle 20 may reciprocate along the first rail 30 in a direction perpendicular to the first reflective surface 11.

However, the first rail 30 provided so that the cradle 20 can move in a direction perpendicular to the first reflective surface 11 is an example according to the first embodiment of the present disclosure, and thus if the cradle 20 can reciprocate in a direction perpendicular to the first reflective surface 11, the first rail 30 is not necessarily provided.

As shown in FIG. 1, the camera 40 photographs the first reflective surface 11 on which the projection area 4 is formed. In this case, the camera 40 is provided as a camera 40 that can detect the corresponding light according to the type of light irradiated from the light source 3 of the LiDAR 2 in order to photograph the projection area 4. In this embodiment, it will be described that the light irradiated by the light source 3 of the LiDAR 2 is infrared, and accordingly, the camera 40 is an infrared camera 40.

The camera 40 is disposed spaced apart from the first reflective surface 11 in order to photograph all of the projection area 4 formed on the first reflective surface 11. Accordingly, it is possible to check the size of the projection area 4 from photographing information taken by the camera 40.

As long as the camera 40 can photograph all of the first reflective surface 11 on one screen, there is no limitation on the location where it is installed. In this embodiment, as shown in FIG. 1, it will be described as being disposed on one rear side of the cradle 20 for fixing the LiDAR 2. Through this, even in the process of reciprocating the cradle 20 in the front-rear direction, it is possible to photograph all changes in the size of the projection area 4 by photographing the entire area of the first reflective surface 11.

The calculator 50 receives photographing information collected by the camera 40 photographing the first reflective surface 11 according to the position of the cradle 20 and determines the field of view of the light source 3 from the photographed information.

In this case, in order for the calculator 50 to determine the field of view of the light source 3, the calculator 50 determines the field of view of the light source 3 on a first axis C1 when opposite ends of the projection area 4 positioned on the first axis C1 are included in the first reflective surface 11.

Describing this in more detail, as shown in FIG. 3, the calculator 50 determines the field of view of the light source 3 by collecting the photographed information including the projection area 4 formed by the light source 3 on the first reflective surface 11 from the photographed information taken by the camera 40 in the process of changing the position of the cradle 20.

In this case, as shown in FIG. 3, in the case of measuring an area where the measurement area of the LiDAR 2 extends left and right along the first axis C1, when one end 4a of the projection area is on the first axis C1 and the other end 4b of the projection area is located more inside than opposite ends of the first reflective surface 11 on the first axis C1, the calculator 50 determines the field of view through the photographed information. Accordingly, it is possible to determine the field of view of the LiDAR 2 in the direction of the first axis C1.

On the other hand, in the case of measuring an area where the measurement area of LiDAR 2 extends along the second axis C2 perpendicular to the first axis C1, when opposite ends of the projection area 4 are located on the second axis C2 more inside than opposite ends of the first reflective surface 11 on the second axis C2, the calculator 50 determines the field of view through the photographed information. Accordingly, it is also possible to determine the field of view of the LiDAR 2 in the direction of the second axis C2.

That is, the position of opposite ends of the projection area 4 are included in the first reflective surface 11 by adjusting the position of the cradle 20 and determined according to the type of LiDAR 2 to measure the field of view. If necessary, when opposite ends of the projection area 4 on the second axis C2 are included on the first reflective surface 11 in a state in which opposite ends of the projection area 4 on the first axis C1 are not included on the first reflective surface 11, the calculator 50 may determine only the field of view in the direction of the second axis C2. However, since the method of measuring the field of view in the direction of the first axis C1 and the method of measuring the field of view in the direction of the second axis C2 are the same, hereinafter, measuring the field of view in the direction of the first axis C1 will be described, and measuring the field of view in the direction of the second axis C2 will be omitted.

Meanwhile, the position of the cradle 20 when the projection area 4 is included in the first reflective surface 11 according to the movement of the cradle 20 may be determined, and then, photographing of the camera 40 may be controlled so that the camera 40 may photograph only at the determined position. Through this, the camera 40 can be efficiently operated.

In addition, in the case of the approximate performance information of LiDAR 2 is not known, the camera 40 may continuously photograph the first reflective surface 11 while moving the cradle 20. This can be done by fixing the LiDAR 2 to the cradle 20 until the projection area 4 is included in the first reflective surface 11 according to the direction of the field of view to be measured based on the photographed information.

In order to measure the field of view in the direction of the first axis C1, the calculator 50 determines the field of view of the light source 3 of the LiDAR 2 based on the photographing information taken by the camera 40 at two different positions. In this case, the two different positions are defined and described as a first position and a second position closer to the first reflective surface 11 than the first position.

As shown in FIG. 1, the calculator 50 determines the field of view of the light source 3′ by comparing the photographing information taken by the camera 40 while the LiDAR 2 is located at the first position and the photographing information taken by the camera 40 while the LiDAR 2′ is located at the second position.

A more detailed description of this is as follows. As shown in FIGS. 1 and 3, the calculator 50 first collects the distance D1 from the first reflective surface 11 to the first position and collects the photographing information taken at the first position while the LiDAR 2 is at the first position. In this case, the calculator 50 determines the distance W1 between opposite ends of the projection area 4 located on the first axis C1 from the photographing information taken at the first position.

In addition, as shown in FIGS. 1 and 3, the calculator 50 collects the distance D2 from the first reflective surface 11 to the second position and photographing information taken at the second position while the LiDAR 2′ is at the second position. In this case, the calculator 50 determines the distance W2 between opposite ends of the projection area 4 located on the first axis C1 from the photographing information taken at the second position.

The calculator 50 determines the field of view Θ of the light source 3 of the LiDAR 2 on the first axis C1 based on the collected information using Equation 1.

$$θ = 2 \cdot {tan}^{- 1} ( \frac{W 1 - W 2}{2 \cdot ( D 1 - D 2 )} ) \qquad [ Equation 1 ]$$

However, when the calculator 50 determines the field of view Θ of the light source 3 on the first axis C1 through Equation 1, it is assumed that the light source 3 irradiates light symmetrically along the first axis C1. Measuring the field of view when light is asymmetrically irradiated from the light source 3 will be described in detail in a modified example of the second embodiment to be described later.

The reason why the field of view Θ of the light source 3 on the first axis C1 can be determined through Equation 1 is due to the fact that the field of view Θ of the light source 3 on the first axis C1 is symmetrically formed. Field of view Θ is obtained by dividing a difference between a distance between one end 4a of the projection area measured at the first position and the other end 4b of the projection area and a distance between one end 4a′ of the projection area measured at the second position and the other end 4b′ of the projection area measured at the second position by two. A difference value between the first position and the second position are respectively two sides excluding the hypotenuse of the right triangle, and thus a value obtained by dividing the field of view Θ by two can be obtained through an inverse tan function.

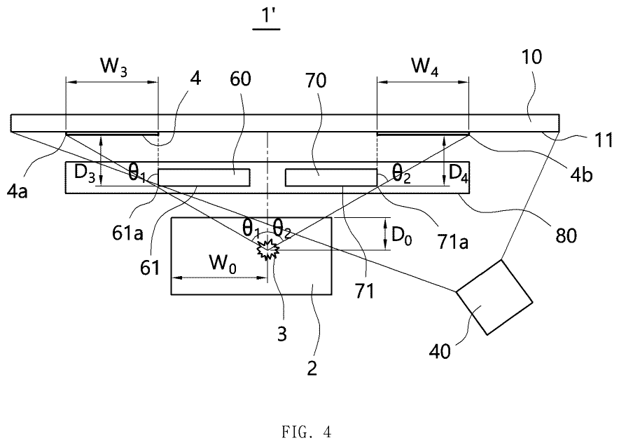

Hereinafter, an apparatus for measuring a field of view of a LiDAR according to an embodiment of the present disclosure will be described with reference to FIGS. 4 to 6.

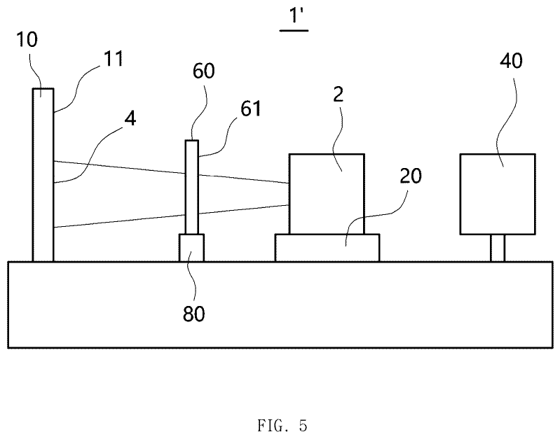

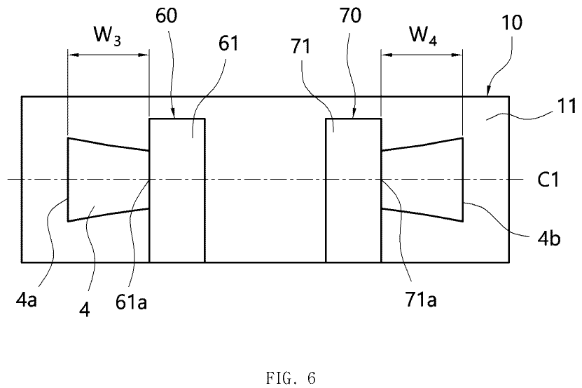

FIG. 4 is a top view of an apparatus for measuring a field of view of a LiDAR according to a second embodiment of the present disclosure. FIG. 5 is a side view of an apparatus for measuring a field of view of a LiDAR according to a second embodiment of the present disclosure. FIG. 6 is a view showing a first reflective surface, a second reflective surface, and a third reflective surface of an apparatus for measuring a field of view of a LiDAR according to a second embodiment of the present disclosure.

As shown in FIG. 4, the apparatus 1 for measuring a field of view of a LiDAR according to a second embodiment of the present disclosure includes a first reflector 10, a cradle 20, a second reflector 60, a second rail 80, a camera 40, and a calculator 50. In this case, since the first reflector 10 and the camera 40 are the same as those of the first embodiment, the description thereof will be replaced with the description of the first reflector 10 and the camera 40 of the first embodiment.

As shown in FIG. 5, the cradle 20 may fix the LiDAR 2 so that a projection area 4 formed by light irradiated by light source 3 is included in a first reflective surface 11. However, the cradle 20 may reciprocate along the first rail 30 like the apparatus 1 for measuring a field of view of a LiDAR according to the first embodiment of the present disclosure described above, and may be installed in a certain position as shown in FIG. 5.

When the cradle 20 is reciprocally movable along the first rail 30, as shown in FIG. 6, the cradle 20 may be moved so that one end 4a of the projection area of the LiDAR 2 or the other end 4b of the projection area of the LiDAR 2 is included in the first reflective surface 11, even in a situation where the basic performance of the LiDAR 2 is not roughly known.

As shown in FIG. 4, the second reflector 60 is disposed between the cradle 20 and the first reflector 10. A second reflective surface 61 is formed on the second reflector 60 toward the light source 3 of the LiDAR 2. In this case, the second reflective surface 61 is formed as a flat surface like the first reflective surface 11. In addition, the second reflective surface 61 is formed parallel to the first reflective surface 11.

As shown in FIG. 4, a projection area 4 may be formed on the second reflective surface 61 by light irradiated from the light source 3, along with the first reflective surface 11. In this case, the second reflective surface 61 is formed smaller than the first reflective surface 11 to prevent the projection area 4 from forming on the first reflective surface 11 because it is blocked by the second reflective surface 61.

In addition, as shown in FIG. 6, one end 61a of the second reflective surface is formed perpendicular to the direction of the field of view of the light source 3 to be measured. Accordingly, it is possible to check the exact position at which the outermost light irradiated toward the one end 61a of the second reflective surface starts to be blocked.

As shown in FIG. 5, the second reflector 60 is installed to be movable in a direction horizontal to the first reflective surface 11. Through this, the second reflector 60 may move until the second reflective surface 61 can block light irradiated to one end 4a of the projection area.

To this end, as shown in FIG. 5, the second reflector 60 may be coupled to the second rail 80. In this case, if the second reflector 60 can move along the second rail 80, the second reflector 60 and the second rail 80 may be coupled by a known coupling method.

The second rail 80 is disposed between the first reflective surface 11 and the cradle 20 and extends in a direction horizontal to the first reflective surface 11 to guide the movement of the second reflector 60. That is, the second reflective surface 61 of the second reflector 60 is disposed toward the light source 3 of the LiDAR 2 fixed to the cradle 20, and the second reflector 60 may reciprocate along the second rail 80 in a direction horizontal to the first reflective surface 11.

However, the second rail 80 provided so that the second reflector 60 can move in a direction horizontal to the first reflective surface 11 is an example according to the second embodiment of the present disclosure, and thus if the second reflector 60 can reciprocate in a direction horizontal to the first reflective surface 11, the second rail 80 is not necessarily provided.

The calculator 50 receives photographing information collected by the camera 40 photographing the second reflective surface 61 according to the positions of the first reflective surface 11 and the second reflector 60, and determines the field of view of the light source 3 from the photographed information.

At this time, the calculator 50 determines the field of view of the light source 3 on the first axis C1 when one end 4a of the projection area located on the first axis C1 is included in the first reflective surface 11 and one end 61a of the second reflective surface is located at a position where it starts to block light irradiated from the light source 3 to one end 4a of the projection area.

Describing this in detail, the second reflector 60 is disposed on the other end 4b side of the projection area. In this state, the outermost light irradiated from the light source 3 may reach the first reflective surface 11.

At this time, when the second reflector 60 is gradually moved toward one end 4a of the projection area, one end 61a of the second reflective surface starts to block the outermost light irradiated from the light source 3. When the second reflector 60 is sufficiently moved, one end of the projection area 4 is formed only on the second reflector 60 and not on the first reflector. Thus, as soon as one end 61a of the second reflective surface starts to block the outermost light irradiated from the light source 3, the second reflector 60 is stopped and the first reflective surface 11 is photographed by the camera 40.

As shown in FIGS. 4 and 6, the calculator 50 collects photographing information obtained by photographing the first reflective surface 11 and a distance D3 from the first reflective surface 11 to one end 61a of the second reflective surface while the second reflector 60 is stopped. In this case, in a state in which one end 61a of the second reflective surface starts to block light irradiated from the light source 3 to one end 4a of the projection area, the calculator 50 determines a distance W3 from one end 4a of the projection area to one end 61a of the second reflective surface along the first axis C1 from the photographed information.

The calculator 50 determines the field of view Θ of the light source 3 of the LiDAR 2 on the first axis C1 based on the collected information using Equation 2.

$$θ = 2 \cdot {tan}^{- 1} ( \frac{W 3}{D 3} ) \qquad [ Equation 2 ]$$

However, when the calculator 50 determines the field of view Θ of the light source 3 on the first axis C1 through Equation 2, it is assumed that the light source 3 irradiates light symmetrically along the first axis C1. Measuring the field of view when light is asymmetrically irradiated from the light source 3 will be described in detail in a modified example of the second embodiment to be described later.

When measuring the field of view using Equation 2, by measuring the field of view by moving only the second reflector 60 without moving the cradle 20 and the LiDAR 2, the error in which the direction of the light source 3 is slightly changed according to the movement of the LiDAR 2 can be prevented. Also, even if only one end 4a of the projection area is included in the first reflective surface 11, the field of view of the light source 3 can be determined, and thus the size of the first reflector 10 can be minimized.

The apparatus 1 for measuring a field of view of a LiDAR, according to a modified example of the second embodiment of the present disclosure, may further include a third reflector 70.

As shown in FIG. 4, the third reflector 70 is disposed between the cradle 20 and the first reflector 10. A third reflective surface 71 is formed on the third reflector 70 toward the light source 3 of the LiDAR 2. In this case, the third reflective surface 71 is formed as a flat surface like the first reflective surface 11. In addition, the third reflective surface 71 is formed parallel to the first reflective surface 11 and the second reflective surface 61.

As shown in FIG. 4, a projection area 4 may be formed on the third reflective surface 71 by light irradiated from the light source 3, along with the first reflective surface 11. In this case, the third reflective surface 71 is formed smaller than the first reflective surface 11 to prevent the projection area 4 from forming on the first reflective surface 11 because it is blocked by the third reflective surface 71.

In addition, as shown in FIG. 6, one end 71a of the third reflective surface is formed perpendicular to the direction of the field of view of the light source 3 to be measured. Accordingly, it is possible to check the exact position at which the outermost light irradiated toward the one end 71a of the third reflective surface starts to be blocked.

As shown in FIG. 5, the third reflector 70 is installed to be movable in a direction horizontal to the first reflective surface 11. Through this, the third reflector 70 may move until the first reflective surface 11 can block light irradiated to one end 4a of the projection area.

To this end, as shown in FIG. 5, the third reflector 70 may be coupled to the second rail 80. In this case, if the third reflector 70 can move along the second rail 80, the third reflector 70 and the second rail 80 may be coupled by a known coupling method.

On the other hand, the third reflector 70 may not be coupled to the second rail 80, but may be coupled to a third rail (not shown) separate from the second rail 80. Although not shown in the drawings, the third rail (not shown) may be disposed parallel to the second rail 80. However, as shown in FIG. 5, in this embodiment, it will be described that the third reflector 70 moves while being coupled to the second rail 80.

Accordingly, in this embodiment, one end of the second reflective surface 61 and one end of the third reflective surface 71 are disposed side by side in a direction parallel to the first axis. The distance D3 between the first reflective surface 11 and one end 61a of the second reflective surface is the same as the distance D4 between the first reflective surface 11 and one end of the third reflective surface.

In this case, the camera 40 further includes a third reflective surface 71 on which a projection area 4 is formed, and so it photographs the first reflective surface 11, the second reflective surface 61, and the third reflective surface 71.

The calculator 50 receives photographing information collected by the camera 40 by photographing the second reflective surface 61 according to the positions of the first reflective surface 11 and the second reflector 60 and photographing information collected by the camera by photographing the third reflective surface 71 according to the positions of the first reflective surface 11 and the third reflector 70, and determines the field of view of the light source 3 from the photographing information.

At this time, the calculator 50 determines a part of the field of view of the light source 3 on the first axis C1 when one end 4a of the projection area located on the first axis C1 is included in the first reflective surface 11 and one end 61a of the second reflective surface is located at a position where it starts to block light irradiated from the light source 3 to one end 4a of the projection area. In addition, it determines the rest of the field of view of the light source 3 on the first axis C1 when the other end 4b of the projection area located on the first axis C1 is included in the first reflective surface 11 and one end 71a of the third reflective surface is located at a position where it starts to block light irradiated from the light source 3 to the other end 4b of the projection area.

In this case, the step of photographing the first reflective surface 11 and the second reflective surface 61 is replaced with the description of the second embodiment. Hereinafter, photographing the first reflective surface 11 and the third reflective surface 71 by moving the third reflector 70 will be described.

First, the third reflector 70 is disposed at one end 4a of the projection area. In this state, the outermost light irradiated from the light source 3 may reach the first reflective surface 11.

At this time, when the third reflector 70 is gradually moved toward the other end 4b of the projection area, one end 71a of the third reflective surface starts to block the outermost light irradiated from the light source 3. When the third reflector 70 is sufficiently moved, the other end of the projection area 4 is formed only on the third reflective surface 71 and not on the first reflector. Thus, as soon as one end 71a of the third reflective surface starts to block the outermost light irradiated from the light source 3, the third reflector 70 is stopped and the first reflective surface 11 is photographed by the camera 40.

As shown in FIGS. 4 and 6, the calculator 50 collects photographing information obtained by photographing the third reflective surface 71 and a distance D4 from the first reflective surface 11 to one end 71a of the third reflective surface while the third reflector 70 is stopped. In this case, in a state in which one end 71a of the third reflective surface starts to block light irradiated from the light source 3 to the other end 4b of the projection area, the calculator 50 determines a distance W4 from the other end 4b of the projection area to one end 71a of the third reflective surface along the first axis C1 from the photographed information.

The calculator 50 determines the field of view Θ of the light source 3 of the LiDAR 2 on the first axis C1 based on the collected information using Equation 3.

$$θ = {tan}^{- 1} ( \frac{W 3}{D 3} ) + {tan}^{- 1} ( \frac{W 4}{D 4} ) \qquad [ Equation 3 ]$$

As above, in the case of determining the field of view Θ using Equation 3, even when the field of view of the light source 3 of the LiDAR 2 is asymmetrically irradiated, the entire field of view Θ can be determined by determining a part of the field of view through the second reflector 60 and determining the rest of the field of view through the third reflector 70.

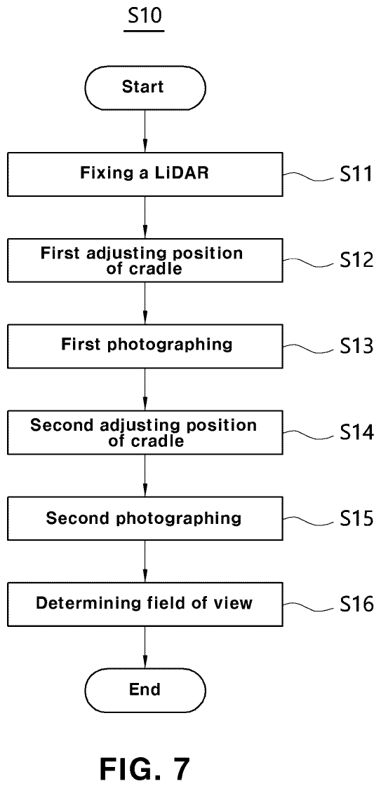

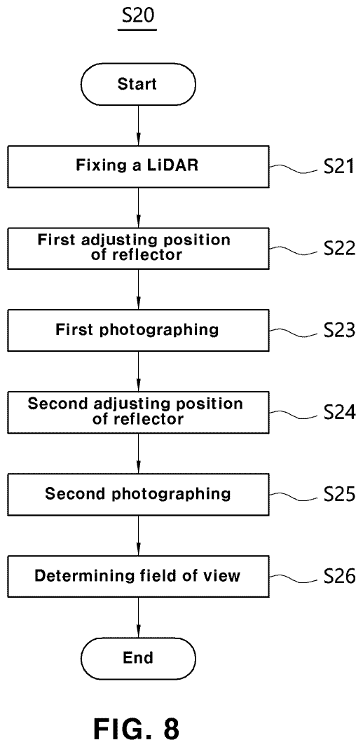

Meanwhile, hereinafter, a method for measuring a field of view of a LiDAR, according to various embodiment of the present disclosure, will be described with reference to FIGS. 7 to 8.

FIG. 7 is a flow chart of a method for measuring a field of view using an apparatus for measuring a field of view of a LiDAR according to a first embodiment of the present disclosure. FIG. 8 is a flow chart of a method for measuring a field of view using an apparatus for measuring a field of view of a LiDAR according to a second embodiment of the present disclosure.

As shown in FIG. 7, the method S10 for measuring a field of view using the apparatus for measuring a field of view of a LiDAR according to a first embodiment of the present disclosure includes fixing a LiDAR at S11, first adjusting a position of a cradle at S12, first photographing at S13, second adjusting a position of a cradle at S14, second photographing at S15, and determining a field of view at S16.

In the step of fixing a LiDAR at S11, a LiDAR 2 is coupled to a cradle 20 so that projection area 4 is formed on a first reflective surface 11 of a first reflector 10 by the light irradiated from a light source 3 of the LiDAR 2. In this case, opposite ends of the projection area 4 formed by irradiating light from the light source 3 may be larger than the first reflective surface 11.

To prevent this, in the step of first adjusting the position of the cradle at S12, the cradle 20 is adjusted to a first position so that opposite ends of the projection area 4 located on the first axis C1 are included in the first reflective surface 11.

In the step of first photographing at S13, the first reflective surface 11 is photographed by a camera 40 while the cradle 20 is located in the first position. In this case, a distance W1 between opposite ends of the projection area 4 located on the first axis C1 may be determined from the photographing information photographed by the camera 40.

In the step of second adjusting a position of a cradle at S14 after completing the photographing with the camera 40 while the LiDAR 2 is located in the first position, the cradle 20 is adjusted to a second position in a state where opposite ends of the projection area 4 on the first axis C1 are included in the first reflective surface 11. The second position is designated as a position closer to the first reflective surface 11 than the first position.

In the step of second photographing at S15, the first reflective surface 11 is photographed by the camera while the cradle 20 is located in the second position. In this case, a distance W2 between opposite ends of the projection area 4 located on the first axis C1 may be determined from the photographing information photographed by the camera 40.

In the step of determining the field of view at S16, the field of view of the light source 3 is determined by comparing the photographing information taken by the camera 40 while the cradle 20 is located at the first position and the photographing information taken by the camera 40 while the cradle 20 is located at the second position.

The calculator 50 further collects a distance D1 from the first reflective surface 11 to the first position while the LiDAR 2 is at the first position and a distance D2 from the first reflective surface 11 to the second position while the LiDAR 2 is at the second position, and may determine the field of view Θ of the light source 3 of the LiDAR 2 on the first axis C1 based on the collected information using Equation 1 described above.

Meanwhile, as shown in FIG. 8, the method S20 for measuring a field of view using the apparatus for measuring a field of view of a LiDAR according to a second embodiment of the present disclosure includes fixing a LiDAR at S21, first adjusting a position of a reflector at S22, first photographing at S23, and determining a field of view at S26. In the method S20 for measuring a field of view using the apparatus for measuring a field of view of a LiDAR according to a second embodiment of the present disclosure, the field of view may be determined without moving the cradle 20.

In the step of fixing a LiDAR at S21, a LiDAR 2 is coupled to a cradle 20 so that projection area 4 is formed on a first reflective surface 11 of a first reflector 10 by the light irradiated from a light source 3 of the LiDAR 2. In this case, the cradle 20 is disposed at a position where opposite ends of the projection area 4 located on the first axis C1 may be included in the first reflective surface 11.

In the step of first adjusting the position of the reflector at S22, the second reflector 60 is moved from the other end 4b of the projection area toward one end 4a of the projection area until one end of the second reflective surface 61 of the second reflector 60 starts to block light irradiated from the light source 3 to one end of the projection area 4 located on the first axis C1.

In the step of first photographing at S23, when one end of the second reflective surface 61 starts to block light irradiated from the light source 3 to one end 4a of the projection area located on the first axis C1, first photographing information is generated by photographing the first reflective surface 11 and the second reflective surface 61 with the camera 40.

In a state in which one end 61a of the second reflective surface starts to block light irradiated from the light source 3 to one end 4a of the projection area, a distance W3 from one end 4a of the projection area to one end 61a of the second reflective surface along the first axis C1 may be determined from the first photographing information.

When the light irradiated from the light source 3 of the LiDAR 2 is symmetrically irradiated, the field of view of the light source 3 may be determined from the first photographing information in the step of determining the field of view at S26. The calculator 50 collects photographing information obtained by photographing the first reflective surface 11 and a distance D3 from the first reflective surface 11 to one end 61a of the second reflective surface while the second reflector 60 is stopped, and then determines the field of view of the light source 3 using Equation 2 described above.

Meanwhile, as shown in FIG. 8, the method S20 for measuring a field of view using the apparatus for measuring a field of view of a LiDAR, according to a modified example of the second embodiment of the present disclosure, may further include second adjusting a position of a reflector at S24 and second photographing at S25 before determining a field of view at S26.

In the step of second adjusting a position of a reflector at S24, the third reflector 70 is moved from the one end 4a of the projection area toward the other end 4b of the projection area until one end of the third reflective surface 71 of the third reflector 70 starts to block light irradiated from the light source 3 to the other end of the projection area 4 located on the first axis C1.

In the step of second photographing at S25, when one end of the third reflective surface 71 starts to block light irradiated from the light source 3 to the other end 4b of the projection area located on the first axis C1, second photographing information is generated by photographing the first reflective surface 11 and the third reflective surface 71 with the camera 40.

In a state in which one end 71a of the third reflective surface starts to block light irradiated from the light source 3 to the other end 4b of the projection area, a distance W4 from the other end 4b of the projection area to one end 71a of the third reflective surface along the first axis C1 may be determined from the second photographing information.

In the step of determining the field of view at S25, the field of view of the light source 3 may be determined from the first photographing information and the second photographing information.

The calculator 50 collects photographing information obtained by photographing the first reflective surface 11 and a distance D3 from the first reflective surface 11 to one end 61a of the second reflective surface while the second reflector 60 is stopped. Second photographing information obtained by photographing the first reflective surface 11 and a distance D4 from the first reflective surface 11 to one end 71a of the third reflective surface while the third reflector 70 is stopped, and then determines the field of view of the light source 3 using Equation 3 described above. As above, in the case of determining the field of view Θ using Equation 3, even when the field of view of the light source 3 of the LiDAR 2 is asymmetrically irradiated, the entire field of view Θ can be determined by determining a part of the field of view through the second reflector 60 and determining the rest of the field of view through the third reflector 70.

As described above, exemplary embodiments according to the present disclosure have been examined, and it is obvious to those skilled in the art that the present disclosure can be embodied in other specific forms without departing from the spirit or scope of the present disclosure in addition to the above-described embodiments. Therefore, the above-described embodiments are to be construed as illustrative rather than restrictive, and accordingly, the present disclosure is not limited to the above description and may be modified within the scope of the appended claims and their equivalents.

Description of Symbols

1, 1′ apparatus for measuring a field of view of a LiDAR
2 LiDAR
3 light source
4 projection area
4a, 4a′ one end of projection area
4b, 4b′ the other end of projection area
10 first reflector
11 first reflective surface
20 cradle
30 first rail
40 camera
50 calculator
60 second reflector
61 second reflective surface
61a one end of second reflective surface
70 third reflector
71 third reflective surface
71a one end of third reflective surface
80 second rail
C1 first axis
C2 second axis

What is claimed is:

1. An apparatus for measuring a field of view of a LiDAR for measuring a field of view of a light source provided in a LiDAR, comprising:
a first reflector having a first reflective surface formed on one side of the first reflector;
a cradle capable of fixing the LiDAR so that a projection area is formed on the first reflective surface by light irradiated by the light source and adjusting a distance between the first reflective surface and the light source;
a camera for photographing the first reflective surface where the projection area is formed; and
a calculator to determine the field of view of the light source from photographing information collected by the camera.

2. The apparatus for measuring a field of view of a LiDAR of claim 1, further comprising:
a first rail extending in a direction perpendicular to the first reflective surface;
wherein the cradle is coupled to the first rail to reciprocate along the first rail.

3. The apparatus for measuring a field of view of a LiDAR of claim 1, wherein when opposite ends of the projection area located on a first axis are included in the first reflective surface, the calculator determines the field of view of the light source on the first axis.

4. The apparatus for measuring a field of view of a LiDAR of claim 3, wherein when opposite ends of the projection area located on a second axis is further included in the first reflective surface, the calculator determines the field of view of the light source on the second axis.

5. The apparatus for measuring a field of view of a LiDAR of claim 3, wherein the calculator determines the field of view of the light source by comparing photographing information taken by the camera while the cradle is located at a first position and photographing information taken by the camera while the cradle is located at a second position.

6. The apparatus for measuring a field of view of a LiDAR of claim 5, wherein the calculator determines the field of view of the light source using Equation 1:
$$θ = 2 \cdot {tan}^{- 1} ( \frac{W 1 - W 2}{2 \cdot ( D 1 - D 2 )} ) \qquad [ Equation 1 ]$$
(where, Θ is a field of view of the light source on the first axis, D1 is a distance from the first reflective surface to the first position, D2 is a distance from the first reflective surface to the second position, W1 is a distance between opposite ends of the projection area located on the first axis while the cradle is located at the first position, and W2 is a distance between opposite ends of the projection area located on the first axis while the cradle is located at the second position).

7. An apparatus for measuring a field of view of a LiDAR for measuring a field of view of a light source provided in a LiDAR, comprising:
a first reflector having a first reflective surface formed on one side of the first reflector;
a cradle capable of fixing the LiDAR so that a projection area formed by light irradiated by the light source is included in the first reflective surface;
a second reflector that is movable between the cradle and the first reflector in a direction horizontal to the first reflector and has a second reflective surface formed on one side of the second reflector;
a camera for photographing the first reflective surface and the second reflective surface on which the projection area is formed; and
a calculator to determine the field of view of the light source from photographing information collected by the camera.

8. The apparatus for measuring a field of view of a LiDAR of claim 7, further comprising:
a second rail extending in a direction horizontal to the first reflective surface;
wherein the second reflector is coupled to the second rail to reciprocate along the second rail.

9. The apparatus for measuring a field of view of a LiDAR of claim 7, wherein when one end of the projection area located on a first axis is included in the first reflective surface and one end of the second reflective surface starts to block light irradiated from the light source to one end of the projection area, the calculator determines the field of view of the light source on the first axis.

10. The apparatus for measuring a field of view of a LiDAR of claim 9, wherein the calculator determines the field of view of the light source using Equation 2:
$$θ = 2 \cdot {tan}^{- 1} ( \frac{W 3}{D 3} ) \qquad [ Equation 2 ]$$
(where, Θ is a field of view of the light source on the first axis, D3 is a distance from the first reflective surface to one end of the second reflective surface, and W3 is a distance from one end of the projection area to one end of the second reflective surface along the first axis in a state in which one end of the second reflective surface starts to block light irradiated from the light source to one end of the projection area).

11. The apparatus for measuring a field of view of a LiDAR of claim 7, further comprising:
a third reflector that is movable between the cradle and the first reflector in a direction horizontal to the first reflective surface and has a third reflective surface formed on one side of the third reflector;
wherein the camera further photographs the third reflective surface where the projection area is formed.

12. The apparatus for measuring a field of view of a LiDAR of claim 11, wherein when one end of the projection area and another other end of the projection area located on a first axis are included in the first reflective surface, one end of the second reflective surface starts to block light irradiated from the light source to one end of the projection area and one end of the third reflective surface starts to block light irradiated from the light source to the other end of the projection area, the calculator determines the field of view of the light source on the first axis.

13. The apparatus for measuring a field of view of a LiDAR of claim 12, wherein the calculator determines the field of view of the light source using Equation 3:
$$θ = {tan}^{- 1} ( \frac{W 3}{D 3} ) + {tan}^{- 1} ( \frac{W 4}{D 4} ) \qquad [ Equation 3 ]$$
(where, Θ is a field of view of the light source on the first axis, D3 is a distance from the first reflective surface to one end of the second reflector, W3 is a distance from one end of the projection area to one end of the second reflective surface along the first axis in a state in which one end of the second reflective surface starts to block light irradiated from the light source to one end of the projection area, D4 is a distance from the first reflective surface to one end of the third reflective surface, and W4 is a distance from the other end of the projection area to one end of the third reflective surface along the first axis in a state in which one end of the third reflective surface starts to block light irradiated from the light source to the other end of the projection area).

14. The apparatus for measuring a field of view of a LiDAR of claim 11, wherein one end of the second reflective surface and one end of the third reflective surface are disposed parallel to each other in a direction parallel to a first axis.

15. A method for measuring a field of view of a LiDAR, comprising:
fixing a LiDAR of coupling the LiDAR to a cradle so that a projection area is formed on a first reflective surface of a first reflector by light irradiated from a light source of the LiDAR;
first adjusting a position of a cradle of adjusting the cradle to a first position so that opposite ends of the projection area located on a first axis are included in the first reflective surface;
first photographing of photographing the first reflective surface with a camera while the cradle is located at the first position;
second adjusting a position of a cradle of adjusting the cradle to a second position while opposite ends of the projection area located on the first axis are included in the first reflective surface;
second photographing of photographing the first reflective surface while the cradle is located at the second position; and
determining a field of view of determining a field of view of the light source by comparing photographing information taken while the cradle is located at the first position and photographing information taken while the cradle is located at the second position.

16. The method for measuring a field of view of a LiDAR of claim 15, wherein in the step of determining a field of view, the field of view of the light source is determined using Equation 1:
$$θ = 2 \cdot {tan}^{- 1} ( \frac{W 1 - W 2}{2 \cdot ( D 1 - D 2 )} ) \qquad [ Equation 1 ]$$
(where, Θ is a field of view of the light source on the first axis, D1 is a distance from the first reflective surface to the first position, D2 is a distance from the first reflective surface to the second position, W1 is a distance between opposite ends of the projection area located on the first axis while the cradle is located at the first position, and W2 is a distance between opposite ends of the projection area located on the first axis while the cradle is located at the second position).

17. A method for measuring a field of view of a LiDAR, comprising:
fixing a LiDAR of coupling the LiDAR to a cradle so that a projection area is formed on a first reflective surface of a first reflector by light irradiated from a light source of the LiDAR;
first adjusting a position of a reflector of moving a second reflector until one end of a second reflective surface of the second reflector starts to block light irradiated from the light source to one end of the projection area located on a first axis;
first photographing of generating first photographing information by photographing the first reflective surface and the second reflective surface; and determining a field of view of determining a field of view of the light source from the first photographing information.

18. The method for measuring a field of view of a LiDAR of claim 17, wherein in the step of determining a field of view, the field of view of the light source is determined using Equation 2:
$$θ = 2 \cdot {tan}^{- 1} ( \frac{W 3}{D 3} ) \qquad [ Equation 2 ]$$
(where, Θ is a field of view of the light source on the first axis, D3 is a distance from the first reflective surface to one end of the second reflective surface, and W3 is a distance from one end of the projection area to one end of the second reflective surface along the first axis in a state in which one end of the second reflective surface starts to block light irradiated from the light source to one end of the projection area).

19. The method for measuring a field of view of a LiDAR of claim 17, further comprising:
prior to the determining a field of view,
second adjusting a position of a reflector of moving a third reflector until one end of a third reflective surface of the third reflector starts to block light irradiated from the light source to the another end of the projection area located on a first axis; and
second photographing of generating second photographing information by photographing the first reflective surface and the third reflective surface;
wherein in the step of determining a field of view, the field of view of the light source is determined by further including the second photographing information.

20. The method for measuring a field of view of a LiDAR of claim 19, wherein in the step of determining field of view, the field of view of the light source is determined using Equation 3:
$$θ = {tan}^{- 1} ( \frac{W 3}{D 3} ) + {tan}^{- 1} ( \frac{W 4}{D 4} ) \qquad [ Equation 3 ]$$
(where, Θ is a field of view of the light source on the first axis, D3 is a distance from the first reflective surface to one end of the second reflector, W3 is a distance from one end of the projection area to one end of the second reflective surface along the first axis in a state in which one end of the second reflective surface starts to block light irradiated from the light source to one end of the projection area, D4 is a distance from the first reflective surface to one end of the third reflective surface, and W4 is a distance from the other end of the projection area to one end of the third reflective surface along the first axis in a state in which one end of the third reflective surface starts to block light irradiated from the light source to the other end of the projection area).
